(19) United States
(12) Patent Application Publication
(10) Pub. No.: US 2014/0167880 A1
(43) Pub. Date: Jun. 19, 2014

(54) PASSIVE COAXIAL POWER SPLITTER/COMBINER

(71) Applicant: TRIQUINT CW, INC., Hillsboro, OR (US)

(72) Inventors: Paul DAUGHENBAUGH, JR., Newbury Park, CA (US); Scott BEHAN, Somis, CA (US); Patrick COURTNEY, Newbury Park, CA (US)

(73) Assignee: TRIQUINT CW, INC., Hillsboro, OR (US)

(21) Appl. No.: 13/719,167

(22) Filed: Dec. 18, 2012

(51) Int. Cl. H01P 5/12

(52) U.S. Cl. CPC H01P 5/12
USPC 333/127; 333/136

(57) ABSTRACT

A passive coaxial signal power splitter apparatus includes an input port, an input coaxial waveguide section coupled to the input port, a guided wave structure coupled to the input coaxial waveguide section, a plurality of antenna elements arranged in the guided wave structure, and an output port coupled to each of the antenna elements. A passive coaxial signal power combiner includes a plurality of input ports, a guided wave structure coupled to the plurality of input ports, a plurality of antenna elements in the guided wave structure, wherein each antenna element is coupled to one or more of the input ports, a coaxial waveguide section coupled to the guided wave structure, and an output port coupled to the coaxial waveguide section.

### FIELD

The invention relates to a device for spatially dividing power of an EM wave. More particularly, the invention relates to a device for passively dividing the EM wave among antenna elements provided within a coaxial waveguide cavity, and coupling each antenna to an output port.

### BACKGROUND

The traveling wave tube amplifier (TWTA) has become a key element in broadband microwave power amplification for radar and satellite communication. One advantage of the TWTA is the very high output power it provides. However, there sometimes exists a requirement for passive splitting of the power for distribution to multiple outputs, either before or after amplification, where the bandwidth covers about a decade of frequency range, such as 2 to 20 GHz. Conversely, there sometimes exists a requirement for passive combining of multiple power streams into a single output, where the passive combiner can operate over a bandwidth that covers about a decade of frequency range, such as 2 to 20 GHz.

### SUMMARY

In an embodiment of the invention, a passive coaxial signal power splitter apparatus includes an input port, an input coaxial waveguide section coupled to the input port, a guided wave structure coupled to the input coaxial waveguide section, a plurality of antenna elements arranged in the guided wave structure, and an output port coupled to each of the antenna elements.

In a further embodiment of the invention, a method of splitting a signal power in a passive coaxial apparatus includes inputting an electrical signal to an input port of the apparatus, transforming the signal to an electromagnetic (EM) wave propagating in a coaxial input waveguide section, coupling the EM wave into a coaxial guided wave structure comprising a plurality of antenna elements, and coupling the EM wave into a plurality of output ports operative coupled to the antenna elements.

In a further embodiment of the disclosure, a passive coaxial signal power combiner includes a plurality of input ports, a guided wave structure coupled to the plurality of input ports, a plurality of antenna elements in the guided wave structure, wherein each antenna element is coupled to one or more of the input ports, a coaxial waveguide section coupled to the guided wave structure, and an output port coupled to the coaxial waveguide section.

In a further embodiment of the disclosure, a method of combining a plurality of signals in a passive coaxial apparatus includes inputting each of a plurality of electrical signals to a corresponding one of a plurality of input ports, coupling the input ports to a guided wave structure, coupling each signal to a corresponding one of a plurality of antenna elements arranged in the guided wave structure, transforming with the antenna elements each signal to a corresponding electromagnetic (EM) wave propagating parallel to a longitudinal axis in the guided wave structure, coupling each corresponding EM wave to propagate in a coaxial waveguide section, wherein the coaxial waveguide section is coupled to the guided wave structure, and coupling the plurality of corresponding EM waves propagating in the coaxial waveguide section to an output port of the apparatus as a single electrical output signal.

### BRIEF DESCRIPTION OF THE DRAWINGS

Many advantages of the present invention will be apparent to those skilled in the art with a reading of this specification in conjunction with the attached drawings, wherein like reference numerals are applied to like elements, and wherein:

FIG. 1A is a perspective view of an embodiment of a power combining system in accordance with the invention;

FIG. 1B illustrates three plan views of a second embodiment of a power combining system in accordance with the invention.

FIG. 2 is perspective view of a wedge shaped tray in accordance with the invention;

FIG. 3A is the cross section of a center waveguide structure which has a plurality of planar surfaces in accordance with the invention;

FIG. 3B is the cross section of center waveguide structure which has a rectangular outside profile and a rectangular coaxial waveguide opening in accordance with the invention;

FIG. 4 is longitudinal cross sections of the input waveguide section in accordance with the invention;

FIG. 5 is a view of an example of an antenna element in accordance with the invention; and

FIGS. 6A-6C show cross sections of the exemplary antenna element of FIG. 5 taken at various locations in accordance with the invention.

### DETAILED DESCRIPTION

The detailed description set forth below in connection with the accompanying drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

In accordance with the invention, a passive broadband spatial power splitting device has an input port, an input waveguide section, a coaxial waveguide section, and a plurality of output ports. The coaxial waveguide section is provided with longitudinally parallel, stacked wedge shaped trays. Antenna elements are mounted on each tray. When the trays are stacked together to form a coaxial waveguide, the antenna elements are disposed into the waveguide and form a dividing array at the input. With the use of antenna elements inside the coaxial waveguide for power dividing, a broadband frequency response may be achieved over a decade or more. For example, a range of about 2 to 20 GHz, or 4 to 40 GHz, may be realized to provide a portion of the input signal at each of the output ports. The antenna element is easy to manufacture using conventional printed circuit board (PCB) processes. Further, the division of a coaxial waveguide into wedge-shaped trays provides good thermal management, if required.

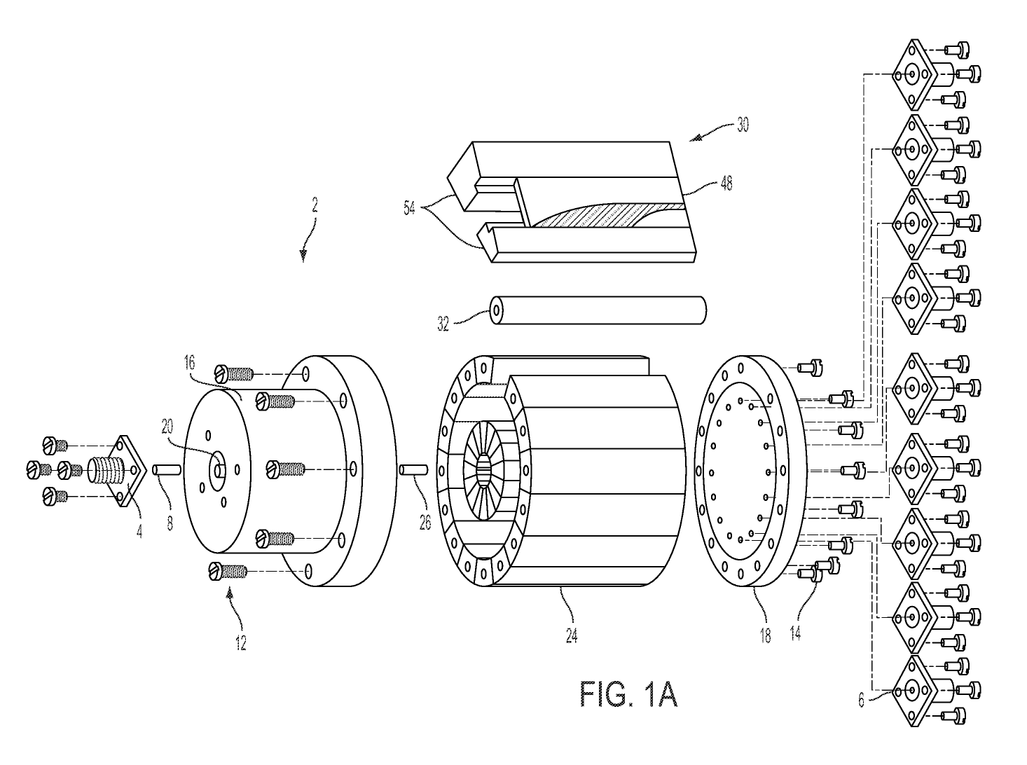

As illustrated in FIG. 1A, in the passive coaxial spatial power splitting device 2 of the invention, an electromagnetic (EM) wave is launched from an input port 4 to an input coaxial waveguide section 12. The EM wave is divided up using a plurality of antennas 48. One or more output ports 6 may be connected at an opposite end of each antenna 48, according to the design of the antenna 48. The input waveguide section 12 provides a broadband transition from the input port 4 to a coaxial waveguide section 24. The outer surfaces of inner conductor 20 and the inner surface of outer conductor 16 all have gradually changed profiles. The profiles may be determined to control or minimize the impedance mismatch from the input/output ports 4 and 6 to the coaxial waveguide section 24. In the example illustrated in FIG. 1A, the coaxial spatial power splitting device 2 has one input port 4 arranged at one end of the input waveguide section 12 and a plurality of output ports 6 arranged on a splitter plate 18 coupled to an end of the coaxial waveguide section 24 opposite the input waveguide section 12 by means of a plurality of screws 14.

In an embodiment, referring to FIG. 1B, the a plurality of output ports 6 may be circumferentially arranged on the outer surface of the coaxial waveguide section 24 instead of on the splitter plate 18. In this example, each of the output ports 6 is coupled to a single antenna element 48. The output ports 6, as shown in this example are oriented radially, i.e., each output port 6 is substantially perpendicular to the longitudinal axis of the input waveguide section 16 and the coaxial waveguide section 24. The splitter plate 18 is replaced by a blank endplate 18A with a plurality of holes 15, to affix the endplate 18A to the coaxial waveguide section 24 with screws 14, as described above.

In an embodiment, the outer surface of inner conductor 20 and the inner surface of the outer conductor 16 have profiles adapted to obtain a transformation of waveguide impedance, if desired.

In a preferred embodiment, the input/output ports 4 and 6 are field replaceable SMA (Subminiature A) connectors, however, other types of connectors may be used. The flanges of the input/output ports 4 and 6 are screwed to the outer conductors 16 and splitter plate 18, respectively, with four screws each, although that number is not crucial, and other types of fasteners may be used. Pin 8 is used to connect between centers of the input port 4 and inner conductors 20. In other embodiments, the input/output ports 4 and 6 may be super SMA connectors, type N connectors, K connectors or any other suitable connectors. The pin 8 can also be omitted, if the input/output ports 4 and 6 already have center pins that can be mounted into inner conductor 20.

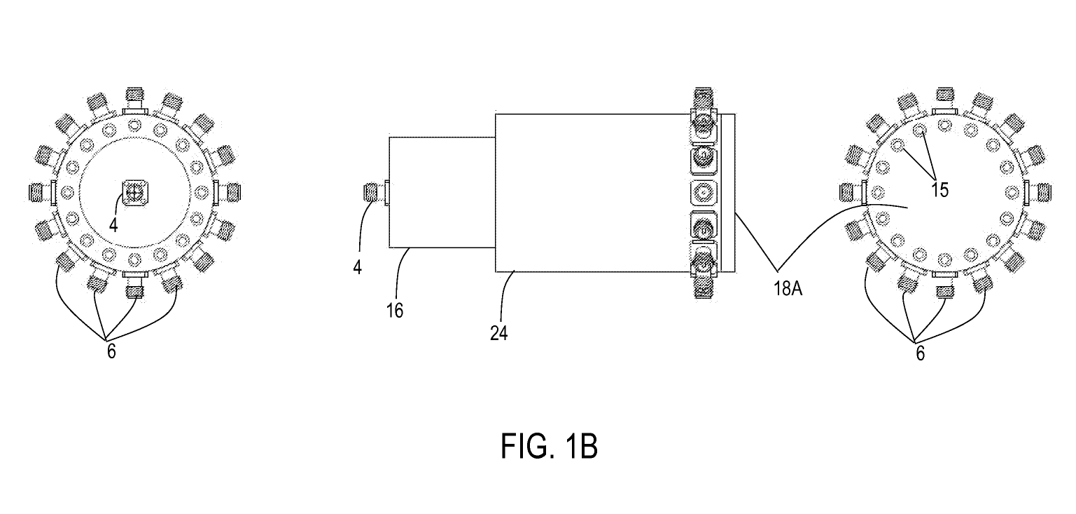

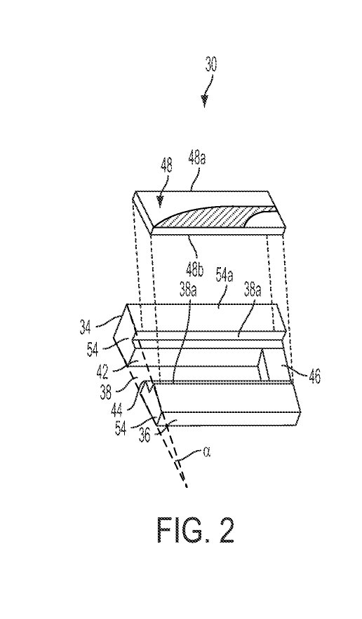

The coaxial waveguide section 24 comprises a plurality of trays 30 and a cylinder post 32 whose major longitudinal axis is coincident with a central longitudinal axis of the coaxial waveguide section 24. The plurality of trays 30 are stacked and aligned circumferentially around the post 32. Each tray 30 includes a carrier 54 (FIG. 2) having a predetermined wedge angle a (FIG. 3), an arcuate inner surface 36 conforming to the outer shape of post 32, and arcuate outer surface 34. When the trays 30 are assembled together, they form a cylinder with a cylindrical central cavity defined by inner surfaces 36 which accommodates the post 32. Post 32 connects with inner conductor 20 of input waveguide section 12 by way of screw 26. Post 32 is provided for simplifying mechanical connections, and may have other than a cylindrical shape, or be omitted altogether.

As detailed in FIG. 2, each tray 30 also includes an antenna (or “antenna element”) 48 and a carrier 54. The carrier 54 has an input cut-out region 38 separating inner and outer portions which are connected by a bridge 46. Opposing major surfaces 42 and 44 of the regions 38 are arcuate in shape. When the trays 30 are stacked together, the region 38 forms a coaxial waveguide opening defined by circular outer and inner surfaces corresponding to arcuate major surfaces 42 and 44, and the arrangement of the antennas 48 on carriers 54 is such that the antennas lie radially about the central longitudinal axis of coaxial waveguide section 24. Alternatively, major surfaces 42 and 44 can be planar, rather than arcuate, such that the coaxial waveguide opening, in cross-section, will be defined by polygonal outer and inner boundaries corresponding to planar major surfaces 42 and 44.

The top surface 54a of metal carrier 54 is provided with recessed edges 38a in the periphery of cut-out region 38, and is recessed in order to accommodate the edges of antenna 48. When in position in a first carrier 54, the back edges of antennas 48 rest in the corresponding recessed edges 38a of the carrier 54, and back faces 48b of the antennas 48 face cut-out regions 38 of that first tray. Contact between the back face 48b of antenna 48 and the corresponding recessed edge 38a of the carrier 54 provides grounding to the antenna 48.

Outer surface 34 of the carrier 54 may be arcuate in shape such that when assembled together, the trays 30 provide the coaxial waveguide section 24 with a substantially circular cross-sectional shape. It is contemplated that other outer surface shapes, such as planar shapes, can be used, in which case the outer cross-sectional shape of the center coaxial waveguide section 24 becomes polygonal. Further, as mentioned above, the carrier has a predetermined wedge angle α, so that the total number of trays 30 in the coaxial waveguide section is given by 360/α, where α is expressed in degrees.

While it is preferred that the outside surfaces 34, 36 of each carrier 54, along with the inside surfaces 42, 44 of the cut-out regions all be arcuate in shape so as to provide for circular cross-sections, it is possible to use straight edges for some or all of these surfaces, or even other shapes instead, with the assembled product thereby approximating cylindrical shapes depending on how many trays 30 are used. FIG. 3A shows an embodiment in which a cross section of the coaxial waveguide section 24 shows that the outside surfaces and inside coaxial waveguide openings are all approximated by straight planes. A polygonal cross-sectional shape results, but if a sufficient number of trays are used, a circular cross section is approximated.

In the preferred embodiment, the wedge shaped trays 30 are radially oriented when stacked together to form a circular coaxial waveguide, as seen schematically in FIG. 3A. However, the trays can have other shapes, which may be different from one another, and a non-cylindrical coaxial waveguide can thus result. FIG. 3B shows such an arrangement, resulting in a rectangular (square) coaxial waveguide. In FIGS. 3A and 3B, the bold solid radial lines represent the antenna structures. The dashed lines represent the inter-tray boundaries.

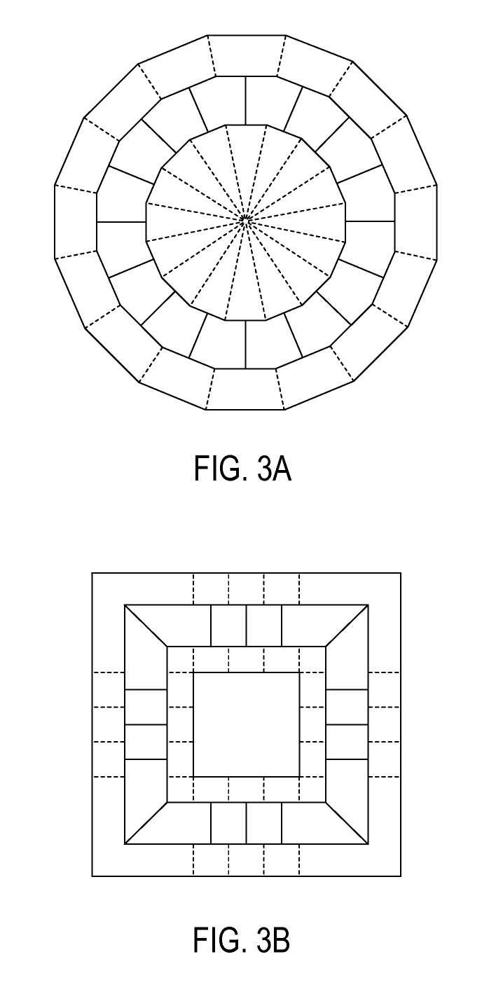

FIG. 4 shows a longitudinal cross-sectional view of the input coaxial waveguide section 12. The waveguide section provides a smooth mechanical transition from a smaller input port 4 (at Zp) to a flared center section 17. Electrically, the waveguide section provides broadband impedance matching from the input port impedance Zp to the center section waveguide impedance Zc. The profiles of the inner conductors and outer conductors are determined by both optimum mechanical and electrical transition in a known fashion.

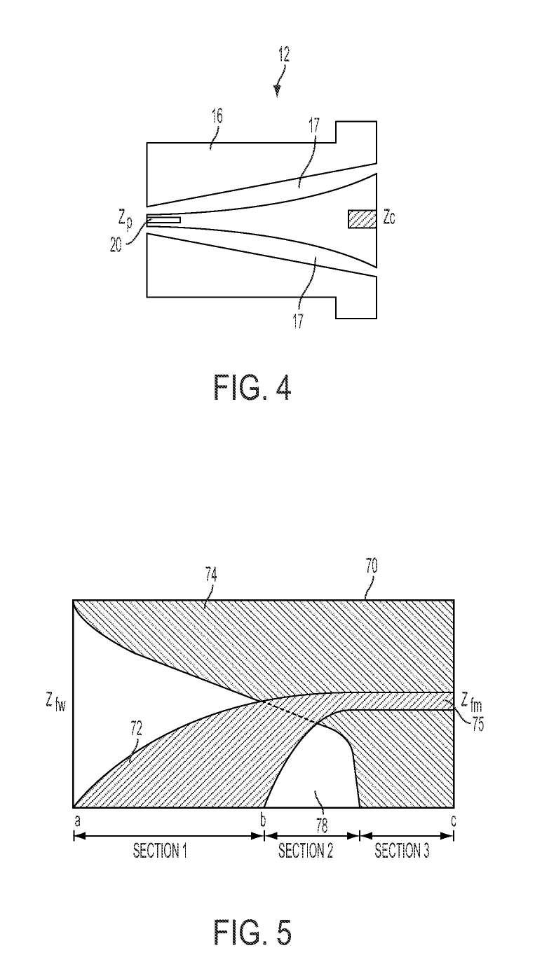

Details of an example of an antenna 70 of the invention are disclosed. The example may be referred to as an antipodal finline structure, but other antenna designs are possible, and the description is intended for purposes of illustration without loss of generality. Referring to FIG. 5, three sections (section 1, between lines a and b, sections 2 and 3, between lines b and c), are delineated in the drawing figures for ease of explanation and discussed separately, with the understanding that these sections are not separate but are actually part of one unitary component. In Section 1, lying between lines a and b, top side (corresponding to side 48a of FIG. 2) metal conductor 72 and back side metal conductor 74 (corresponding to side 48b of FIG. 2) are shown to expand in area outward respectively from the lower and upper edges of the substrate 76. In Section 2, top side conductor 72 narrows to a strip 75, while back side conductor 74 expands to a wider ground that has substantially the same width as the substrate. Section 3 has a straight microstrip line on the top side, and a back side conductor as ground, forming a microstrip waveguide. This arrangement is easier to manufacture by eliminating a conventional balun as is know in the prior art, while still offering good compatibility with commercial off-the-shelf monolithic integrated circuits (COTS MMICs). The tapered 3-section antipodal finline is referred to herein as an antipodal finline taper. In a preferred embodiment, e.g., in the 2-20 GHz bandpass range, the overall length of an antipodal finline taper is about 2.4 inches. For other decade bandwidths, the preferred overall length may differ.

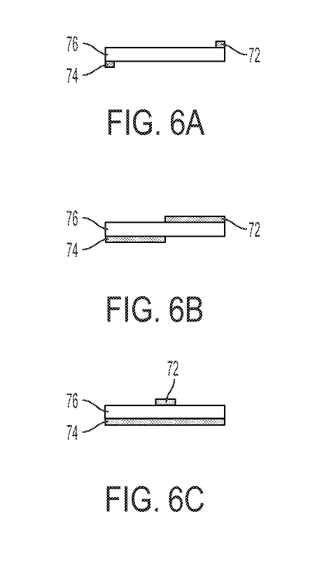

FIGS. 6A-6C show the cross sections of the antipodal finline taper taken along lines a, b and c. The top side conductor 72 and back side conductor 74 are preferably disposed on a soft PTFE based substrate 76. The substrate can also be any other suitable material, such as ceramic, or non-PTFE substrate. The cross sections of FIGS. 6A-6C show the gradual changes of the top and back side metal conductors from left side to the right side. The top side conductor 72 becomes wider first and then narrower as a microstrip line. The back side conductor 74 becomes wider, then a ground plane.

A profile of the conductive patterns of the top side conductor 72 and back side conductor 74 on the substrate 76 of the antenna 48 may be designed by well know principals, e.g., the theory of small reflections, to minimize reflection of the traveling EM wave. The profile of conductive patterns on the antenna 48 is judiciously chosen to avoid exciting multimode resonance at higher frequency (i.e., cutoff) and response deterioration at lower frequency. Other antenna patterns than that just described, and multi-layer antennas may be considered as well, including antennas that have more than two conductive layers.

As described above, with respect to the antipodal finline taper, the top side conductor 72 becomes wider first and then narrower as a microstrip line. The back side conductor 74 becomes wider, then a ground plane. In an embodiment, the microstrip line of each antenna 48 may couple to a center terminal of an output port 6 arranged in the splitter plate 18. Thus, the plurality of antennas 48 may each be adapted to couple a fraction of the total power input to the power splitting device 2 out through the output ports 6.

In an embodiment, an antenna may be designed to couple and transform power in the EM field into more than one microstrip line on the same substrate 76, thereby permitting power distribution to more than one output port 6 per antenna element. The ratio of power split into each output port 6 may be according to the arrangement of one or more different antenna designs. Thus, for example, if all antennas are identical and each terminating in a single microstrip, the power splitting ratio at each output port 6 may be approximately the input power divided by the number of output ports.

It should be appreciated that the power splitter 2 may be operated in reverse. That is, separate electrical signals may be applied to the output ports 6 as if they were input ports. The signal is transformed by the respective antenna 48 into an EM field traveling backward to the input waveguide section 12, which then feeds the signal to the input port 4. Thus, a plurality of electrical signals, which may each contain different information content, or occupy a different portion of the operational spectrum of the power splitter 2, may be combined into one composite signal at the port 4.

It may be further appreciated that the power splitter 2, whether operated in forward or reverse mode, may have an operational bandwidth up to, and greater than, a decade of frequency, such as, for example, 2 to 20 GHz, or 4 to 40 GHz, but not limited to these frequency ranges.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A passive coaxial signal power splitter apparatus comprising:
an input port;
an input coaxial waveguide section coupled to the input port;
a guided wave structure coupled to the input coaxial waveguide section;
a plurality of antenna elements arranged in the guided wave structure; and
a plurality of output ports, wherein each output port is coupled to only one of the antenna elements.

2. The apparatus of claim 1, wherein more than one output port may be coupled to any one of the antenna elements.

3. The apparatus of claim 1, wherein the input port is arranged to launch an electromagnetic (EM) wave into the input coaxial waveguide, and wherein the input coaxial waveguide is arranged to couple the EM wave to the guided wave structure.

4. The apparatus of claim 1, wherein the input coaxial waveguide section is arranged to guide the EM wave having the electric field directed radially and propagating parallel to a longitudinal axis.

5. The apparatus of claim 1, wherein the guided wave structure is coaxially cylindrical having an inner radius and an outer radius.

6. The apparatus of claim 5, wherein each of the plurality of antenna elements are arranged in a radial direction from the inner radius to the outer radius of the guided wave structure.

7. The apparatus of claim 6, wherein the plurality of antenna elements transform the radial EM field into a guided wave having a substantially circumferential direction of the electric field in each of the antenna elements.

8. The apparatus of claim 7, wherein each output port is arranged in an output plate and is coupled to one of the antenna elements.

9. The apparatus of claim 7, wherein each output port is arranged on an outer surface of the guided wave structure and is coupled to one of the antenna elements.

10. The apparatus of claim 9, wherein the axis of orientation of each output port is substantially perpendicular to the longitudinal axis of the input waveguide section.

11. A passive coaxial signal power splitter apparatus comprising:
an input port configured to receive an electrical signal;
an input coaxial waveguide having a coaxial longitudinal axis configured to transform the signal to an electromagnetic (EM) wave, the EM wave having an electric field in a radial direction and propagating along the longitudinal axis;
a guided wave structure configured to split the EM wave into a plurality of lower power electrical signals; and
a plurality of output ports each being configured to output a different one of the lower power electrical signals.

12. The apparatus of claim 9, wherein the guided wave structure comprises a plurality of antenna elements arranged to transform the EM wave into the plurality of the lower power electrical signals.

13. The apparatus of claim 12, wherein each of the plurality of antenna elements are arranged in a radial direction from the inner radius to the outer radius of the guided wave structure.

14. The apparatus of claim 13, wherein the plurality of antenna elements transform the radial EM field into a guided wave having a substantially circumferential direction of the electric field in each of the antenna elements.

15. The apparatus of claim 12, wherein each output port is coupled to a single antenna element.

16. The apparatus of claim 12, wherein more than one output port may be coupled to a one of the antenna elements.

17. A passive coaxial signal power combining apparatus comprising:
a plurality of input ports each configured to receive an electrical signal;
a guided wave structure coupled to the plurality of input ports configured to transform the plurality of signals to a plurality of electromagnetic (EM) waves;
a coaxial waveguide section coupled to the guided wave structure for combining the plurality of EM waves into a single output signal; and
an output port coupled to the coaxial waveguide section for outputting the output signal.

18. The power combiner of claim 17, wherein the guided wave structure is approximately coaxially cylindrical having an inner radius and an outer radius.

19. The apparatus of claim 18, wherein the guided wave structure comprises a plurality of antenna elements, wherein each of the antenna elements is coupled to one or more of the input ports.

20. The apparatus of claim 19, wherein each of the plurality of antenna elements is arranged radially in the guided wave structure.

21. The apparatus of claim 20, wherein each antenna is configured to transform the electrical signal from an input port to an EM wave having an electric field with a substantially radial direction.

22. The apparatus of claim 17, wherein the input ports are arranged on an input plate and the input plate is coupled to the guided wave structure.

23. The apparatus of claim 17, wherein the input ports are arranged on an outer surface of the guided wave structure.

24. A passive coaxial signal power combining apparatus comprising:
a plurality of input ports;
a guided wave structure coupled to the plurality of input ports;
a coaxial waveguide section coupled to the guided wave structure; and
an output port coupled to the coaxial waveguide section.

25. The apparatus of claim 24, wherein the guided wave structure is approximately coaxially cylindrical having an inner radius and an outer radius.

26. The apparatus of claim 25, wherein the guided wave structure comprises a plurality of antenna elements, wherein each of the antenna elements is coupled to one or more of the input ports.

27. The apparatus of claim 26, wherein each of the plurality of antenna elements is arranged radially in the guided wave structure.

28. The apparatus of claim 27, wherein each antenna is configured to transform the electrical signal from an input port to an EM wave having an electric field with a substantially radial direction.

29. The apparatus of claim 27, wherein the input ports are arranged on an input plate and the input plate is coupled to the guided wave structure.

30. The apparatus of claim 27, wherein the input ports are arranged on the on the outer surface of the guided wave structure and is coupled to one of the antenna elements.
